(19) United States
(12) Patent Application Publication
(10) Pub. No.: US 2005/0151510 A1
(43) Pub. Date: Jul. 14, 2005

(54) Perpetual motion fan module

(76) Inventor: Rudolph V. Bailey, Bear, DE (US)

Correspondence Address: RUDOLPH V. BAILEY SR., 140 Antlers Lane, Bear, DE, 19701, US

(21) Appl. No.: 11/076,527

(22) Filed: Mar. 9, 2005

Related U.S. Application Data
(63) Continuation of application No. 10/811,382, filed on Mar. 27, 2004.
Application No. 10/811,382 is a continuation of application No. 10/075,569, filed on Feb. 13, 2002, now abandoned.
(60) Provisional application No. 60/303,871, filed on Jul. 9, 2001.
(60) Provisional application No. 60/349,731, filed on Jan. 17, 2002.
(60) Provisional application No. 60/644,725, filed on Jan. 18, 2005.

(51) Int. Cl. H02J 7/00

(52) U.S. Cl. 320/116

(57) ABSTRACT

A means for creating perpetual motion of a battery operated device has been disclosed. A battery operated device such as a large commercial fan can be made to operate continuously eliminating the need for a separate re-charging process for the batteries as long as the fan is kept in operation. This can be accomplished having at least two batteries which are connected in series to give the desired volts, and at least two charging components to charge each battery separately, as the fan is used.

### DESCRIPTION OF RELATED APPLICATIONS

This application is a continuation of CO-pending application Ser. No. 10/811,382 Filed on Mar. 27, 2004, which was a continuation of application Ser. No. 10/075,569 Filed on Feb. 13, 2002, which claimed benefit of 60/303,871 filed on Jul. 9, 2001, and also claimed benefit of 60/349,731 filed on Jan. 17, 2002. This Application is also a Continuation-in-part of CO-pending Application Serial No. U.S.60/644,725 Filed on Jan. 18, 2005.

### BACKGROUND OF THE INVENTION

This version of the invention is concerned with the field of battery operated devices, which employs a system of re-charging the batteries while the device is used, therefore allowing the devices to operate continuously.

1. Prior Art

A variety of battery operated devices are on the market, which uses re-chargeable batteries, but all posses common limitations, which are as following: Their duration of operation is limited to the extent that batteries must to be re-charged periodically in order to continue their usage. This means that the operation must be stopped during the re-charging process, or the changing of said batteries for fresh ones. Additionally said devices operates weaker and weaker as said batteries are used, not allowing full efficiency of the devices they are used to operate.

What is needed therefore to overcome these limitations is a way to replenish re-chargeable batteries, while the devices they power are in use, so that no interruption of operation, or loss of efficiency, or waste of time will be experienced.

2. Discussion of the Prior Art

Attempts are continuously being made to fill this need as is exemplified in U.S. Pat. No. 4,648,013, self-charging Solar Batteries, issued to Raymond F. Curiel on Mar. 3, 1987, and U.S. Pat. No. 5,998,965 Direct plug-in power tool using single Pair of contacts for both AC and DC Currents, issued to Vito J. Carlucci, and Harold R. Taylor on Dec. 7, 1999; and U.S. Pat. No. 4,677,362 apparatus for storing and charging a re-chargeable electric tool, issued to Lawrence E, House, 11 and William H. O'Connor on Jan. 30, 1987.

As illustrated by the background art, efforts are continuously being made in an attempt to develop ways of re-charging the battery of battery operated devices as said devices are being used. However all of these attempts fall short of their intended purposes, as they have other limitations. For example with both inventions of House and Carlucci one must have an electrical outlet to perform the re-charging of said batteries as said devices are used. In a situation where no electrical outlet is available their systems would not work. In addition the users mobility would be restricted to the length of the electrical re-charging cord. In Cruel's invention solar plates are incorporated in the device in order to use the Sun's rays to accomplish the re-charging of said batteries. However the Sun does not always shine, so that system cannot always be relied on for continuous use. No prior effort provides the benefits attendant with the present invention. As such, it may be appreciated that there is a continuing need for a new and improved system to replenish batteries for battery operated devices as said devices are being used. In this respect, the present version of the invention substantially departs from the conventional concepts, and designs of the prior art, and in so doing provides a system that substantially fulfills this need. Additionally, the prior patents and commercial techniques do not suggest the present inventive combination of component eliminates arraigned and configured as disclosed herein.

The present invention achieves its intended purposes, objects and advantages through a new, useful and unobvious combination of methods steps and component elements, with the use of a minimum number of functioning parts, at a reasonable cost to manufacture, and by employing only readily available materials.

### SUMMARY

The present version of the invention, which will be described in greater detail hereinafter, relates to the field of large battery operated devices which uses re-chargeable batteries. More specifically, this version of the invention is concerned with a battery operated fan module, which incorporates a system of re-cycling the energy within the system, and splitting the energy molecule, as the energy is re-cycled, and taking one energy molecule and make two, thereby increasing the re-cycled energy enough to offset that which is loss due to friction, and also enough to do useful work. The said process will facilitate perpetual motion of said fan module. At this point I am requesting the examiner to read CO-pending continuation-in-part Application Serial No. U.S.60/644,725 Filled on Jan. 18, 2005, Said application will answer all questions about how the new perpetual motion science, avoids breaking the laws of thermodynamics and the laws of energy conversion, yet increases the energy within the system without need of any outside energy to keep the system in operation. We found it necessary to simplify this application due to the complexity and controversy of the subject matter. The subject continuation-in-part application deals with the new science of perpetual motion, and the energy molecule splitter and comptrollers that are used to facilitate perpetual motion, This application deals with how to build and how to operate a new useful perpetual motion machine.

Thank you for reading CO-pending Continuation-in-part Application serial No. U.S.60/644,725. Our version of the invention overcomes all of the shortcomings listed previously, in addition to novel aspects that will be described in detail hereinafter.

Described briefly, according to a typical embodiment, the invention presents a Fan Module for the purpose of moving air for the comfort of human kind, or animals, especially in a situation where no other form of electrical source is available, like a tent city in remote areas, or deserts, for camping and such like. The invention can also be modified for many other purposes and applications that are not covered by this application, but will follow in other CO-pending applications. The device is contained in a non-conductive enclosure with removable top and front and rear access doors, and is comprised in general of three 1-HP-24 volt DC motors, two 12-volt deep cycle batteries connected to give 24 volts, two 12-volt alternators, and four alternator solenoids, an energy molecule splitter and Comptroller, and a large fan unit, one torque drive shaft, and one speed drive shaft with rotary transmission means. A computer with touch monitor, and an extension speaker, and a remote communicator/controller.

The reason we use three one horse power motors instead of one 3-HP motor is to save on cold cranking amps on start ups. A, 3-HP-24 volt DC motor will draw about 120 steady amps while a, 1-HP motor will draw about 40, steady amps, so we start up the system with just one motor, then turn the others on one at a time, this procedure saves us steady amps, as well as cold cranking amps on start up. We divide the total horse power we need from the motor by 3, and one motor should be able to run the system at no load. The other motor should take care of the charging process while the last motor should account for the work load. The three motors working together with the torque ratio chosen should be able to keep the machine in operation under the total work load. The torque ratio give the difference between the speed in RPM of the drive motor and speed of the torque shaft in RPM. The torque ratio x the total motor HP gives the horse power torque ratio equivalency (HPTRE) of the machine, this is the most work the machine can do and continue to operate. A factor of safety should always be factored in.

Next the speed shaft must return the machine to the drive motor speed in RPM, that means the same ratio must be use on the speed side in RPM. The speed shaft will allow the alternator to rotate as fast as needed to perform the charging process, taking into account that the drive motors must be rested equally, as was explained in CO-pending continuation-in-part application serial No. U.S.60/644,725. The energy molecule splitter and comptroller will control the charging process one alternator at a time, and allow the drive motor its rest periods. For example it the comptroller allows a 1-minute charging of each battery, plus a 1-minute rest for the drive motors, that is a 3-minute charging cycle. Therefore the alternators must travel 3-times as fast as the drive motor, in order keep up volt for volt, revolution for revolution, amp for amp, with said drive motor. So then if the drive motor operates at 1,800 RPM then the alternators must operate at 5,400 RPM, to keep the machine in operation, for a 3-minute charge cycle. As mentioned in said CO-pending application, we must calculate the total amps the machine will use, and the alternators should be able to produce 25-35% more amps at that speed in RPM, in order to keep the machine in operation, as a rule that should not be a problem.

The torque shaft should be over 1 inch in diameter. The reason is that we need to use extra heavy duty pillow blocks, and most manufactures of pillow blocks only make heavy duty pillow blocks over 1 inch in diameter. The speed shaft can be smaller as standard pillow blocks will work. The rotary transmission means can be chain and sprocket or polyp chain. Polyp chain is much quieter and offers less friction, and it is our choice, but it is very expensive compared to chain and sprocket, We recommend this over belt and pulley drive, because they give little or no slippage with less belt tension.

The drive motor should operate in a counter clockwise rotation in concert with the earth's rotation, this may seem trivial, but one must realize that friction is an enemy of perpetual motion machines, the smallest amounts of friction that we can eliminate with each step, will add up to make a difference. All shafts must be on the same horizontal or vertical plane. Proper alignment of all drive mechanism and proper belt adjustments are very important. “The rule of thumb” must be followed, which is as following: When the machine is completely assembled one should be able to use the thumb and two fingers at one of the motor shafts, and must be able to rotate the entire machine freely, (please wear leather gloves, and make shore that the power is locked out, or not connected).

Our invention, therefore, resides not in any one of these features per se, but rather in the particular combination of all of them herein disclosed. It is distinguished from the prior art in this particular combination of all of its structures for the functions specified.

In order that the detailed description of the invention may be better understood, and that the present contribution to the art can be more fully appreciated, additional features of the invention will be described hereinafter. It should be appreciated by those skilled in the art, that the conception and the disclosed specific methods and structures may be readily utilized as a basis for modifying of designing other structures for carrying out the same purposes of the present invention. It should be realized by those skilled in the art, that such equivalent methods and structures, do not depart from the spirit and scope of the invention.

In this respect, before explaining at least one embodiment of the invention in detail, it is to be understood that the invention is not limited in its application to the details of construction and to the arrangement of the components set forth in the following description, or illustrated in the accompanying drawing. The invention is capable of other embodiments, and of being practiced and carried out in various ways. Also, it is to be understood that the phraseology and terminology employed herein are for the purpose of description and should not be regarded as limiting.

As such, those skilled in the art will appreciate that the conception, upon which the disclosure is based, may be readily be utilized as a basis for the designing of other structures, methods and systems for carrying out the several purposes of the present invention.

Further, the purpose of the foregoing abstract is to enable the U.S. Patent and Trademark Office and the public generally, and especially the scientists, and engineers and practitioners in the art who are not familiar with patent or legal terms or phraseology, to determine quickly from a cursory inspection the nature and essence of the technical disclosure of the application. The abstract is neither intended to define the invention of the application, nor is it intended to be limiting as to the scope of the invention in any way.

Accordingly, it is an object of our version of the invention to provide a low-cost, easy-to-manufacture, and easy-to-market perpetual motion fan module.

A further object of our version of the invention is to provide an easy to use and versatile perpetual motion fan module.

A significant object of the invention is to provide a perpetual motion fan module that is transportable, compact and easy to store when not needed.

A final but significant object of the invention is to provide a perpetual motion fan module that can function in an environment where no other source of electrical energy is available, or practical.

For a better understanding of the invention, its operating advantages and the specific objects attained by its uses, references should be made to the accompanying drawing and descriptive matter in which there is illustrated a preferred embodiment of the invention. The foregoing has outlined some of the more pertinent objects of the invention. These objects should be construed to be merely illustrative of some of the more prominent features and applications of the present invention. Many other beneficial results can be attained by applying the disclosed invention in a different manner, or by modifying the invention within the scope of the disclosure. Accordingly, other objects and a fuller understanding of the invention may be had by referring to the summary of the invention, and the detailed description of the preferred embodiment, in addition to the scope of the invention illustrated by the accompanying drawing.

### BRIEF DESCRIPTION OF THE DRAWING

The foregoing and other objects, features and advantages of the invention will become more fully understood from the following description of the preferred embodiment of the invention as illustrated in the accompanying drawing, in which like reference characters refer to the same parts throughout different views. The drawing is not necessarily to scale, emphasis instead being placed upon illustrating the principles of the invention.

FIG. 1 is a plan view of a perpetual motion fan module in accordance with the present version of the invention.

FIG. 1A is a plan view of the internals of a energy molecule splitter and comptroller in accordance with the present version of the invention.

### DESCRIPTION OF THE PREFERRED EMBODIMENT

Description

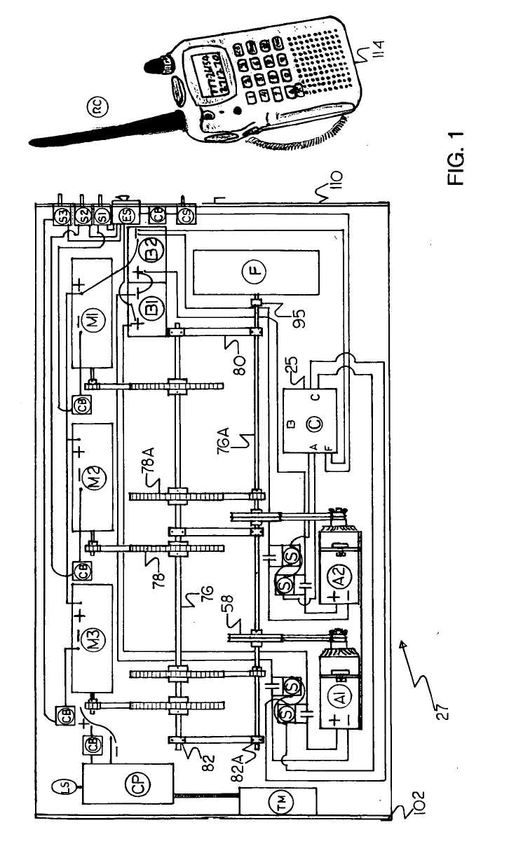

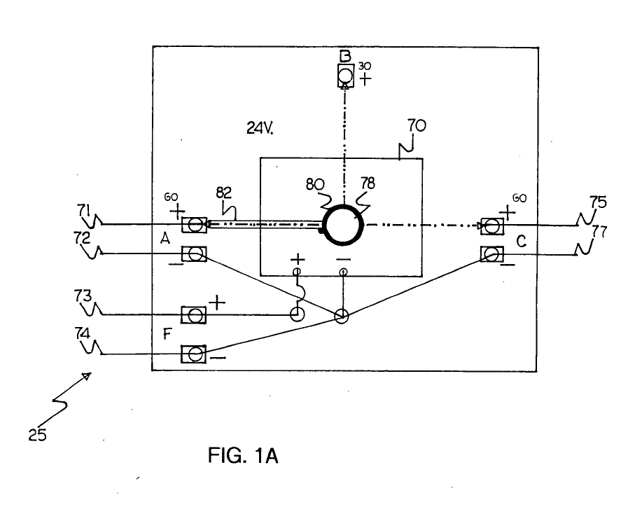

Referring now to the drawing and, in particular, to FIG. 1 wherein there is illustrated a typical embodiment of a perpetual motion fan module 27. The present version of the invention 27 is constructed of a wooden enclosure cabinet, or other non-conductive material such as plastic, fiber glass, or any other such like material, or a combination thereof. The cabinet should have a removable top cover, and a front access door 110, and a rear access door 102. The doors should have vent louvers to permit venting of moving parts. The base should be made sturdy enough to support the weight of all component parts. Swivel caster wheels can also be installed for easy movement of module. Lifting lugs can be installed to allow for mechanical lifting devices to be used in moving module. The base should be constructed to allow for a forklift to get under it. The invention 27 consist of three 24 volt one horse power motors (M1, M2, M3,) or any other suitable ratings. Included also are two 12-volt, 225-amp Alternators (A1, A2,) or any other suitable ratings or charging components capable of producing more energy than needed to operate device 27. Included also are two 12-volt deep cycle batteries (B1, B2,) or any other suitable ratings or DC power cells. The present invention is a 24 volt perpetual motion fan module, but any other size or value can be made. In addition the present invention can be modified for other uses, which will be explored in other continuation-in-part applications. The invention 27 also includes a fan unit F connected to speed shaft 76A, and a computer CP, with a touch monitor TM, and loud speaker LS and an energy molecule splitter and comptroller 25. The device 27 also includes four alternator solenoids S, and a remote control and communicator 114, and two drive shafts 76 & 76A, driven by rotary transmission means of polyp chain and sprocket 78 & 78A. Any other rotary transmission means can be used, like lube free chain and sprocket, or belt and pulley. The torque shaft 76 should be supported by extra heavy duty pillow blocks 82, and the speed shaft 76A should be supported by standard pillow blocks 82A. The layout can be as shown in FIG. 1 or speed shaft 76A and alternators A1 & A2 can be placed on top cover outside of enclosure, with fan F also on top, making the unit higher but not as wide. Supports 80 should be sturdy enough to support the weight and stress of the drive mechanism. When the invention 27 is assembled as shown in FIG. 1, and as explained in the summary of the invention, and the specification, and all proper safety, such as circuit breakers CB, and emergency switch ES are installed. When alternator solenoids S are in place as shown, and motor switches (S1, S2, S3) are installed, and all wiring is done to all applicable codes; And computer positive wire is connected to emergency switch ES. When all probes, wires, and appropriate controls are wired. Additionally when comptroller and energy splitter 25 is wired as illustrated in FIG. 1 & FIG. 1A, the unit will be ready for operation. Manual operation is as following: Open rear and front access doors 102 & 110 FIG. 1, make sure that all switches are in the off position. Turn on main switch ES, then turn on motor switch S1, device 27 should be set in motion, and fan F should be in operation. After 20-seconds turn on switch S2, motor M2 should be in operation, After 20-seconds turn on Switch S3 motor M3 should be in operation. After 20 seconds turn on Comptroller switch CS, comptroller and energy molecule splitter 25 will send 24 volt to alternator A2 solenoid's coils. Said action will close normally open contacts for 12-volt positive and negative wires to battery B2, Said action will allow alternator A2 to charge battery B2 for a 1-minute interval. At the end of-one minute comptroller 25 will switch power to comptroller's B position, this will allow drive motors (M1, M2, M3,) to rest in a no-charging position for 30-Seconds, an optional no-charging light can be connected to comptrollers B position. At the end of 30-seconds comptroller 25 will send 24 volts to alternator A1 solenoid's coil for 1-minute, said action will cause alternator A1 to charge battery B1 for a 1-minute initial. At the end of 1-minute comptroller 25 will send power back to the B no-charging terminal to rest the drive motors for another 30-seconds, before sending power back to its A terminal for 1-minute, to repeat the foregoing cycle as long as the device 27 is in operation. Said action which was explained in CO-pending Continuation-in-part Application No. U.S.60/644,725, will cause fan F to operate indefinitely, without need for any outside energy to keep the invention 27 in operation. For internal operation of unit 25, refer to above mention CO-pending Application U.S.60/644,725.

Shutdown procedure: In an emergency turn off emergency switch ES, the entire system including computer CP will be shut down, then manually turn all switches to the off position. This procedure can also be used for a non-emergency shutdown, or the start-up procedure can be done in reverse. If device 27 will not be used for a long time, the batteries can be kept fresh by computer CP. With all switches in the off position, turn emergency switch ES to the on position. Computer CP will monitor the condition of batteries (B1 & B2). When a slight drop in volts occurs, computer CP will turn device 27 on automatically, long enough to re-furbish batteries, and then it will turn the unit off again. This procedure will be repeated on a as needed basis as long as device 27 is out of service. Fan F should be disconnected by depressing quick disconnect coupler 95, and disabling fan while not in use.

Computer start-up procedure: Device 27 can be restarted either by remote control & communicator 114, or by using touch monitor TM. To start-up by touch monitor, touch screen, and a menu will appear, touch auto start (Note only emergency switch ES need to be in the on position for auto start-up). Computer CP will start the unit automatically. Before starting the unit computer CP will ask some questions, like, is fan coupler connected, are all switches in the off position, are unit access doors open, Should I proceed with start-up procedure. A yes answer to all questions will result in an automatic start-up. Computer CP can communicate, and receive Voice verbal communication, or it can be done by written instructions on touch monitor. Device 27 can be shutdown in the same manner by touching monitor and choosing automatic shutdown, and responding positively to all shutdown questions. When disconnecting Fan coupler make sure Emergency switch ES is in the off position. Before shutting down, computer may wait until device 27 completes a full charge cycle, and inform operator of the same.

Start-up and shut-down with remote control & communicator 114, press * twice and menu will appear on display screen, scroll with up or down with arrow and choose auto/start, from menu, then press * once and a signal will be transmitted to computer CP, then answer all startup questions by pressing 1 for yes, and 2 for no. The same can be done verbally, by pressing * 3-times at the beginning. Computer CP can also be manually switched to voice communications. To shut down follow the same procedure and choose auto stop, and answer all shut down questions. Remote control & communicator 114 can also be used as a mobile phone, and two-way radio.

Alarms and instructions: If a problem arises with a component part such as a weak battery or a malfunction charging component or such like, Computer CP can alert operator of same, by voice or sound such as a horn or bell. Said sound or verbal communication will be heard through loud speaker LS, and or remote control & communicator 114. Values of volts, amps, RPM, and such like can also be displayed on touch monitor TM and remote 114. Computer CP, touch monitor TM, extension speaker LS and remote communicator 114, and comptroller 25 are all covered in CO-pending Continuation-in-part Application Serial # U.S.60/644,725 filed on Jan. 18, 2005. As such a patent is not sought in this application for comptrollers and energy Splitter 25, Computer CP with touch monitor TM, and loud speaker LS, or remote communicator 114, in order to avoid double patenting. However, the spirit of what they accomplish is vital to this application, and they are mentioned in this regard, to show how they function with a perpetual motion machine, and more specifically with device 27. Prose applicant, request the granting of a patent on this useful new unobvious perpetual motion fan module, as presented in present application which blades delivers cooling comfort to Human kind, or Animals.

### DRAWING REFERENCE NUMERALS AND NOMENCLATURE

25 Energy Molecule Splitter/Comptroller
58 Alternator Pulley (2)
71 Positive Wire to (A2) Solenoid
72 Negative Wire to (A2) Solenoid
73 24 volt Positive Feed Wire from Battery
74 24 volt Negative Feed Wire from Battery
75 Positive wire to (A1) Solenoid
76 Torque Shaft
76A Speed Shaft
77 Negative Wire to (A1) Solenoid
78 Polyp Chain & Sprocket or Lube Free chain and sprocket
78A Polyp Chain & Sprocket or Lube Free Chain and sprocket
80 Shaft and Pillow Block Support
82 Extra Heavy Duty Pillow Blocks
82A Standard Pillow Blocks
95 Quick Disconnect coupler
102 Rear Access Door
110 Front Access Door
114 Remote Control & Communicator
Al 12-volt-225-amp Alternator
A2 12-volt-225-amp Alternator
CB Circuit Breaker
CP. Central Processing Unit
CS Comptroller Switch
ES Emergency Switch
F Fan
LS Loud Speaker
Ml 1-Horse Power 24-volt DC Motor
M2 1-HP 24-volt DC Motor
M3 1-HP 24-Volt DC Motor
S Alternator Solenoid (4)
S1 Motor # 1 Switch
S2 Motor # 2 Switch
S3 Motor #3 Switch
TM Touch Monitor

### RAMIFICATION SCOPE AND CONCLUSION OF INVENTION

From the foregoing, it will be understood by persons skilled in the art that an improved perpetual motion fan module has been provided. The invention is relatively simple and easy to manufacture, yet affords a variety of uses. While my description contains many specifications, these should not be construed as limitations on the scope of the version of the invention, but rather as an exemplification of the preferred embodiment thereof. For example any value of voltage, amps, horse power, or such like quantity, or any type of battery, of charging component or drive motor or rotary transmission means that may be proven to work better, may be used. The foregoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be resorted to, falling within the scope of the invention. Although this invention has been described in its preferred form with a certain degree of particularity, it is understood that the present disclosure of the preferred form has been made only by way of example, and numerous changes in the details of construction and combination and arraignment of parts may be resorted to, without departing from the spirit and the scope of the invention.

1. What I claim is the independent means to deliver perpetual turning motion to a battery operated fan or device comprising:
(a) providing DC batteries connected in series to operate DC motors and
(b) providing means to increase torque enough to perform all needed work and
(c) providing charging components capable to refurbish each battery separately and
(d) providing means to increase speed in RPM enough to allow said charging components to deliver more energy than needed to operate system and
(e) providing fan unit connected to speed shaft whereby said charging components refurbishes said batteries and supply enough energy to keep system in operation without need for outside energy as said components are appropriately interconnected and installed in proper cabinet whereby said device delivers perpetual turning motion to said fan's blades which deliver cooling comfort for human kind.
